(19) United States
(12) Patent Application Publication
(10) Pub. No.: US 2015/0120527 A1
(43) Pub. Date: Apr. 30, 2015

(54) SYSTEM AND METHOD FOR MANAGING LEASE OF PROPERTIES

(71) Applicant: Tencent Technology (Shenzhen) Company Limited, Shenzhen (CN)

(72) Inventor: Chang HE, Shenzhen (CN)

(21) Appl. No.: 14/327,199

(22) Filed: Jul. 9, 2014

Related U.S. Application Data
(63) Continuation of application No. PCT/CN2014/076415, filed on Apr. 28, 2014.

(30) Foreign Application Priority Data
Oct. 29, 2013 (CN) 201310522461.0

(51) Int. Cl. G06Q 40/02

(52) U.S. Cl. CPC G06Q 40/025
USPC 705/38

(57) ABSTRACT

A method for managing leases of properties to different users is performed at a computer server. The computer server receives a lease initiation request from a client device, the lease initiation request including a property location identifier and a user identifier. After identifying the property, the computer server determines whether the property is available for lease. If so, the computer server instructs a property control device to release the property, updates a lease record for the property, and sends a lease initiation message to the client device, the lease initiation message including an identifier of the lease record. After receiving a lease termination request from the client device, the computer server causes the property control device to repossess the property, updates the lease record to reflect that the property is available for another lease, and sends a lease termination message to the client device.

### RELATED APPLICATIONS

This application is a continuation application of PCT Patent Application No. PCT/CN2014/076415, entitled “SYSTEM AND METHOD FOR MANAGING LEASE OF PROPERTIES” filed on Apr. 28, 2014, which claims priority to Chinese Patent Application No. 201310522461.0, entitled “A RENTAL PROCESSING METHOD, ASSOCIATED DEVICE AND SYSTEM,” filed on Oct. 29, 2013, both of which are incorporated by reference in their entirety.

### TECHNICAL FIELD

The disclosed implementations relate generally to the field of property rental management, and in particular, to system and method for leasing real or personal properties to users.

### BACKGROUND

Nowadays, it is quite common for people to lease real or personal property, such as a car, a bicycle, a locker, a parking spot, etc. Traditionally, a person has to work with at least one administrator on the site of the rental properties and accomplish multiple tasks before possessing the property, e.g., completing a form, providing credit card, and receiving a paper copy of a receipt for the leased property as a proof of the rental transaction. If the person loses the receipt when returning the leased property, he or she may be fined or asked to provide additional information. This approach is not only time-consuming but also increases the rental cost.

### SUMMARY

In accordance with some implementations of the present application, a method for managing leases of properties to different users is performed at a computer server having one or more processors and memory storing program modules to be executed by the one or more processors. The method includes the following steps: receiving a lease initiation request from a client device, the lease initiation request including a property location identifier and a user identifier; identifying a property associated with the property location identifier and determining whether the property is available for lease; in accordance with a determination that the property is available for lease: causing a property control device to release the property; updating a lease record for the property, the lease record including the property location identifier, the user identifier, and a first timestamp corresponding to an initiation of the lease of the property; and sending a lease initiation message to the client device, the lease initiation message including an identifier of the lease record; receiving a lease termination request from the client device, the lease termination request including the identifier of the lease record; in response to the lease termination request, causing the property control device to repossess the property; after confirmation by the property control device of repossessing the property: updating the lease record for the property, the lease record including a second timestamp corresponding to a termination of the lease of the property; and sending a lease termination message to the client device.

In accordance with some implementations of the present application, a method for managing leases of properties to different users is performed at a property control device having one or more processors and memory storing program modules to be executed by the one or more processors. The method includes the following steps: presenting a unique property location identifier for each of a plurality of properties for lease; receiving a property release message from a remote server, the property release message including a property location identifier; in response to the property release message, releasing a property associated with the property location identifier in the property release message to a user; receiving a property repossession message from the remote server, the property repossession message including the property location identifier; in response to the property repossession message, determining whether the user has surrendered the property associated with the property location identifier; after determining that the property has been surrendered: repossessing the property surrendered by the user; and sending a property repossession confirmation message to the remote server.

In accordance with some implementations of the present application, a computer system includes one or more processors; memory; and one or more programs stored in the memory and to be executed by the one or more processors, the program modules including instructions for: receiving a lease initiation request from a client device, the lease initiation request including a property location identifier and a user identifier; identifying a property associated with the property location identifier and determining whether the property is available for lease; in accordance with a determination that the property is available for lease: causing a property control device to release the property; updating a lease record for the property, the lease record including the property location identifier, the user identifier, and a first timestamp corresponding to an initiation of the lease of the property; and sending a lease initiation message to the client device, the lease initiation message including an identifier of the lease record; receiving a lease termination request from the client device, the lease termination request including the identifier of the lease record; in response to the lease termination request, causing the property control device to repossess the property; after confirmation by the property control device of repossessing the property: updating the lease record for the property, the lease record including a second timestamp corresponding to a termination of the lease of the property; and sending a lease termination message to the client device.

In accordance with some implementations of the present application, a non-transitory computer readable storage medium stores one or more program modules configured for execution by a computer system that includes one or more processors and memory storing one or more program modules, the program modules including instructions for: receiving a lease initiation request from a client device, the lease initiation request including a property location identifier and a user identifier; identifying a property associated with the property location identifier and determining whether the property is available for lease; in accordance with a determination that the property is available for lease: causing a property control device to release the property; updating a lease record for the property, the lease record including the property location identifier, the user identifier, and a first timestamp corresponding to an initiation of the lease of the property; and sending a lease initiation message to the client device, the lease initiation message including an identifier of the lease record; receiving a lease termination request from the client device, the lease termination request including the identifier of the lease record; in response to the lease termination request, causing the property control device to repossess the property; after confirmation by the property control device of repossessing the property: updating the lease record for the property, the lease record including a second timestamp corresponding to a termination of the lease of the property; and sending a lease termination message to the client device.

### BRIEF DESCRIPTION OF DRAWINGS

The aforementioned implementation of the present application as well as additional implementations will be more clearly understood as a result of the following detailed description of the various aspects of the present application when taken in conjunction with the drawings. Like reference numerals refer to corresponding parts throughout the several views of the drawings.

FIG. 1 is a block diagram of a network environment for managing leases of properties to different users according to some embodiments of the present application;

FIG. 2 is a block diagram of a user leasing and returning a property controlled by a property control device by communicating with a lease management server using a client device according to some embodiments of the present application;

FIG. 3A is a block diagram of a lease management server according to some embodiments of the present application;

FIG. 3B is a block diagram of a property leasing table according to some embodiments of the present application;

FIG. 4 is a block diagram of a property control device according to some embodiments of the present application; and

FIGS. 5A to 5H illustrate how a user uses a mobile terminal to lease/return a property controlled by a property control device.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

As noted above, the conventional approach of leasing a real or personal property from its owner or administrator is problematic because it is a time-consuming and error-prone process. For example, people often drive their own car to the airport or train station and park the car at a nearby garage before boarding the airplane or train. As a proof of using the garage's parking service, a driver receives a paper ticket from the garage. The ticket usually has a magnetic strip indicating when the car was parked at the garage. When the driver returns to the garage to pick up his or her car, e.g., after a business trip, the driver needs to present the paper ticket to the administrator to determine the parking fee and then makes a payment to the parking garage before the administrator releases the driver. Since the ticket is usually generated when the driver arrives at the entrance of the garage, it does not have the location information of a specific parking spot where the car will be parked. Therefore, the driver has to make extra effort to remember the location of the parking spot. To make it worse, the driver may lose or damage the parking ticket due to its small size and paper nature. When this happens, the driver has to spend more time at the parking garage before being released.

Another type of car parking is the meter-based parking. In this case, the driver estimates how long he or she needs to park the car at the parking spot (e.g., 30 minutes or three hours) and then enters a corresponding amount of cash (usually coins) into the slot of a parking meter adjacent the parking spot. There are two issues with this approach. First, the driver needs to have cash (or even coins) in his or her pocket because most of the parking meters do not accept credit card payment. Second, it is almost impossible for the driver to know exactly in advance how long the car needs to be parked at the parking spot. To avoid receiving a parking citation, the driver probably has no other choice but to over-pay the parking meter.

People run into similar issues with leasing other types of properties. For example, many attraction sites offer bicycle rental services for a fee. Currently, a visitor has to rent a bicycle from an on-site person managing the bicycle rentals and receives a paper ticket for using the bicycle rental service. If the visitor loses the ticket, he or she may have to pay a fine if the bicycle's rental fee depends on the length of the rental period.

The wide spread of mobile payments using mobile terminals like smartphones and tablets makes it possible to implement a more efficient and cost-effective approach of managing leases of properties to different users. As will be described below, using a mobile terminal, a user can perform the entire transaction of leasing and returning a real or personal property online, which is not only more efficient but also more secure.

According to some embodiments, functionalities of a smartphone can be used to lease a property from a property control device and return the property to the property control device after usage. Although the property for lease may be a real property or a personal property, the process of leasing a parking spot and surrendering the parking spot will be described below in detail. But one skilled in the art would understand that the process described in this application is applicable to the process of leasing/returning another property.

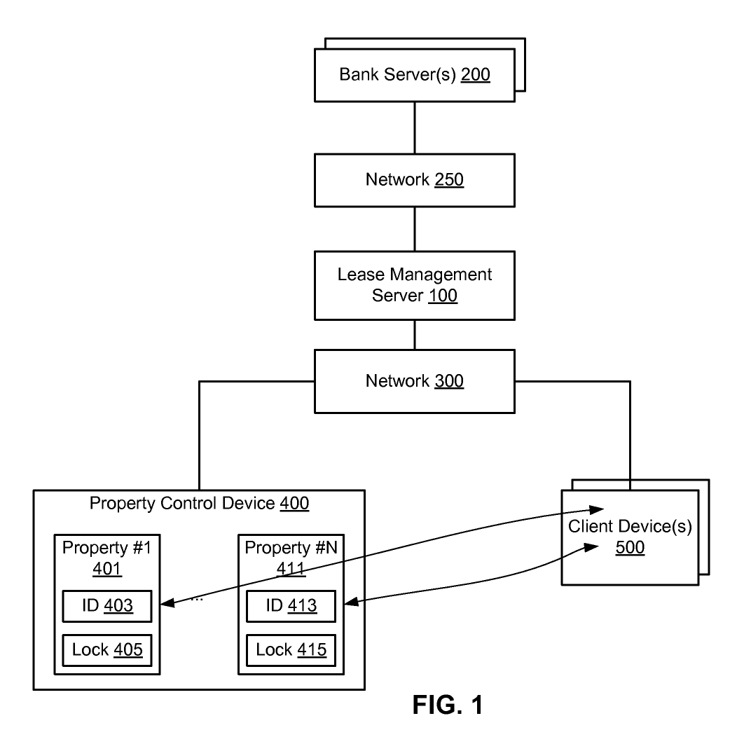

FIG. 1 is a block diagram of a network environment for managing leases of properties to different users according to some embodiments of the present application. As shown in FIG. 1, the property control device 400 includes one or more properties (property #1 401, . . . , property #N 411), each property having a property ID (403 or 413) and an optional lock (405 or 415). If the property for lease is a parking spot within a parking garage, the lock may not be required. If the property for lease is a locker, the lock is required so that a user can put his or her own valuables into the locker. For illustrative purpose, it is assumed that the property for lease is a parking spot and no lock is required. In some embodiments, an electronic device is deployed adjacent a parking spot. As will be described, the electronic device can display a property location identifier of the parking spot or broadcast the property location identifier in the form of audio fingerprints. Electronic devices deployed at different locations are wired to the property control device 400, which is typically a computer or a dedicated device including one or more micro-controllers, so that the property control device 400 can issue instructions to respective electronic devices, which causes the lock or unlock of the properties or the display or update of the property IDs. The property control device 400 is communicatively connected to a lease management server 100 via the network 300, which may be wired or wireless or a combination of both.

The lease management server 100 is a computer server for managing the leases of properties to different users. In some embodiments, the lease management server 100 is communicatively connected to one or more bank servers 200 via the network 250. As will be described below, if a user chooses to make mobile payment for the leasing expense from his or her smartphone, the lease management server 100 may need to determine whether there is a sufficient amount of credit at a bank account associated with the user before releasing the property. In this case, the lease management server 100 provides the user identifier or the like to the bank server 200 so that the bank server 200 can tell whether the user has enough money to pay for leasing the property. In addition, the lease management server 100 is communicatively connected to one or more client devices 500 (e.g., smartphones). Each client device installs a mobile application for communicating with the lease management server 100. For example, after parking his or her car at an empty parking spot, a driver uses his or her smartphone to acquire the property ID displayed on an electronic device near the parking spot and sends a lease initiation request to the lease management server 100 for the parking spot. The lease management server 100 then performs a series of operations to complete the leasing transaction.

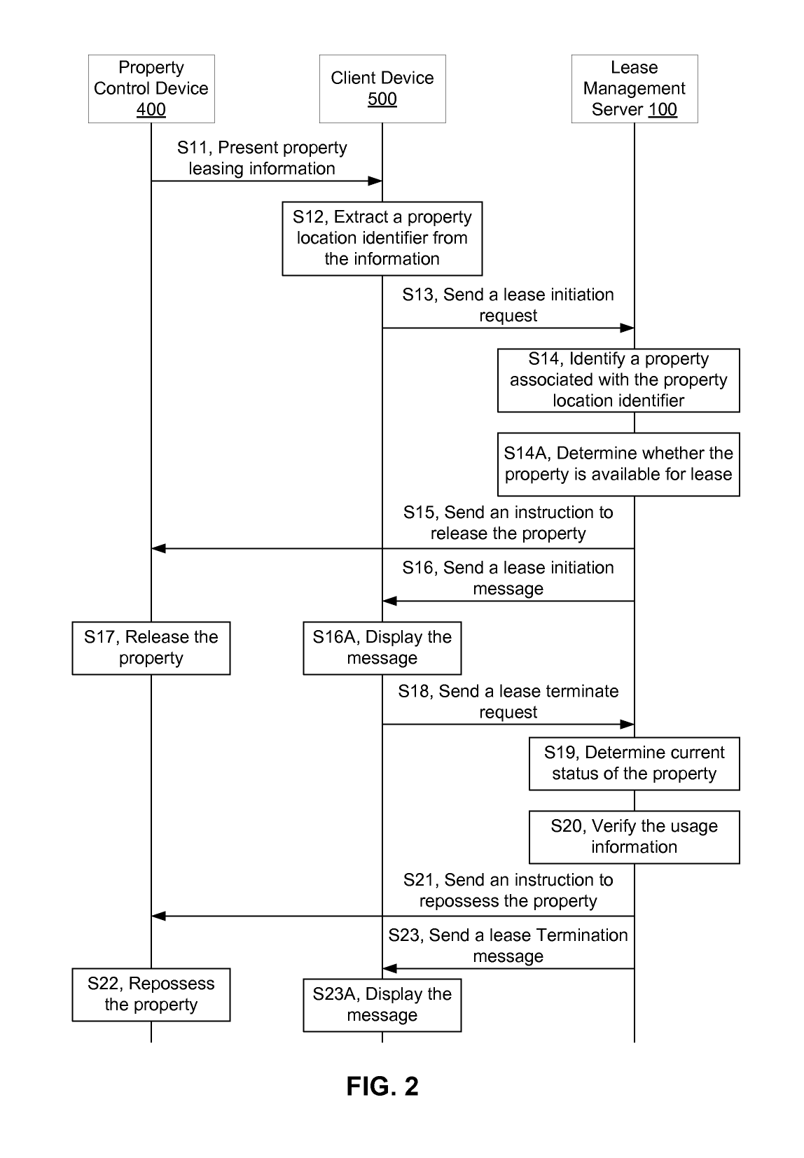

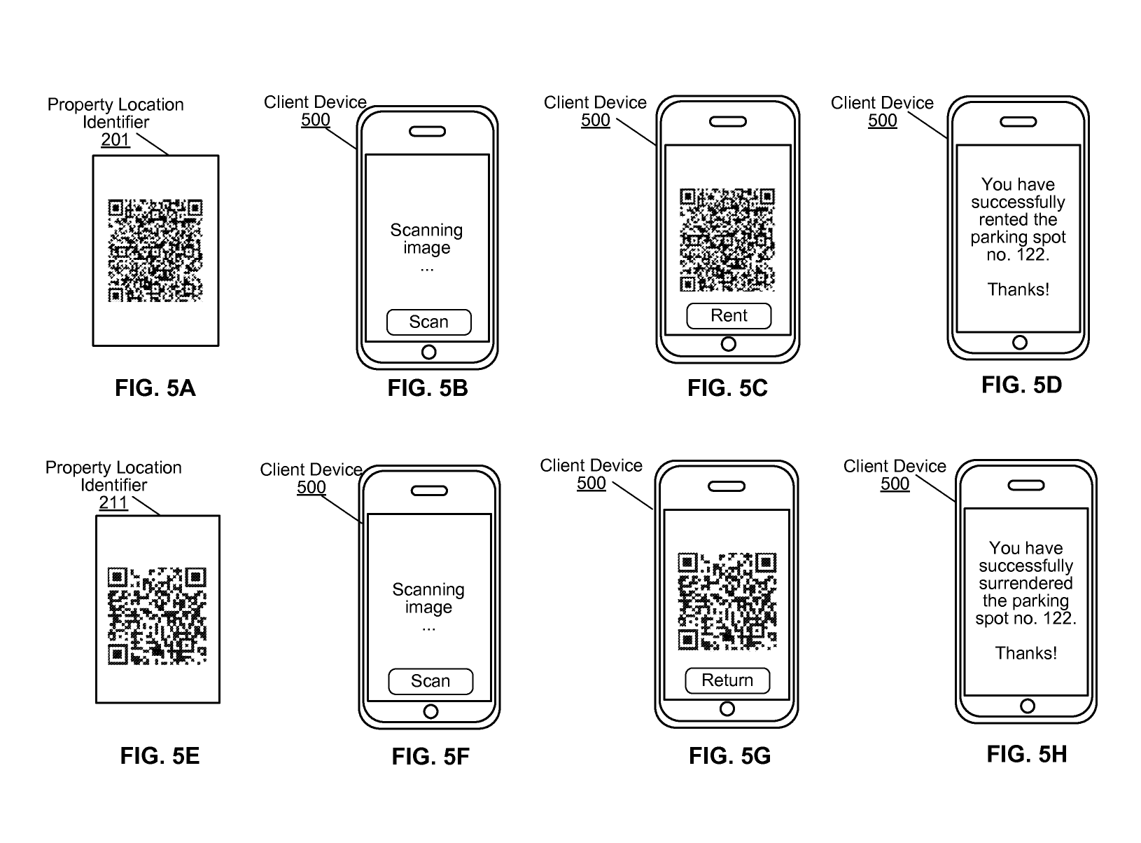

FIG. 2 is a block diagram of a user leasing and returning a property controlled by the property control device 400 by communicating with the lease management server 100 using the client device 500 according to some embodiments of the present application. Using the parking spot as an example, at S11, the property control device 400 (or an electronic device located near the parking spot and controlled by the parking management device 400) presents property leasing information to potential users of the parking spot. In some embodiments, the property leasing information includes a unique property location identifier associated with the parking spot. If the property for lease is a personal property such as a bicycle stored on a rack at a bicycle rental site, the property location identifier may identify a location on the rack housing the bicycle or the bicycle itself. In the latter case, the property location identifier is uniquely associated with the property for lease. As shown in FIG. 5A, the unique property location identifier 201 may be a 2D barcode appearing on a display. In some other embodiments, the property control device 400 generates an audio fingerprint for the unique property location identifier and broadcasts the audio fingerprint at the parking spot. In some embodiments, the audio fingerprint may be broadcast at a frequency outside the frequency range that can be heard by human being. In other words, the audio fingerprint can be detected by the client device 500 but not audible by human beings.

At S12, the client device 500 extracts the property location identifier from the information provided by the property control device 400. In some embodiments, the property control device 400 encrypts the information. The client device 500 decrypts the information and then extracts the property location identifier from the decrypted information. As shown in FIG. 5B, the user may press the “scan” button on the display of the client device 500 to scan the 2D barcode shown in FIG. 5A. FIG. 5C depicts a display of the 2D barcode captured by the client device 500. In order to complete the lease of the parking spot, the user sends a lease initiation request at S13. FIG. 5C depicts that the user can do so by pressing the “rent” button below the 2D barcode. In some embodiments, the lease initiation request includes a timestamp indicating when the lease starts. In some other embodiments, the lease initiation request is generated and submitted to the lease management server 100 by the property control device 400. In this case, the user of the client device 500 causes the client device 500 to send a unique user identifier to the property control device 400, e.g., by displaying a 2D barcode associated with the user on the display of the client device 500 so that the property control device 400 can scan the 2D barcode. Except that the lease initiation request is submitted from the property control device 400, the rest of the rental process is similar to the one described below in connection with FIGS. 2 and 5A-5H.

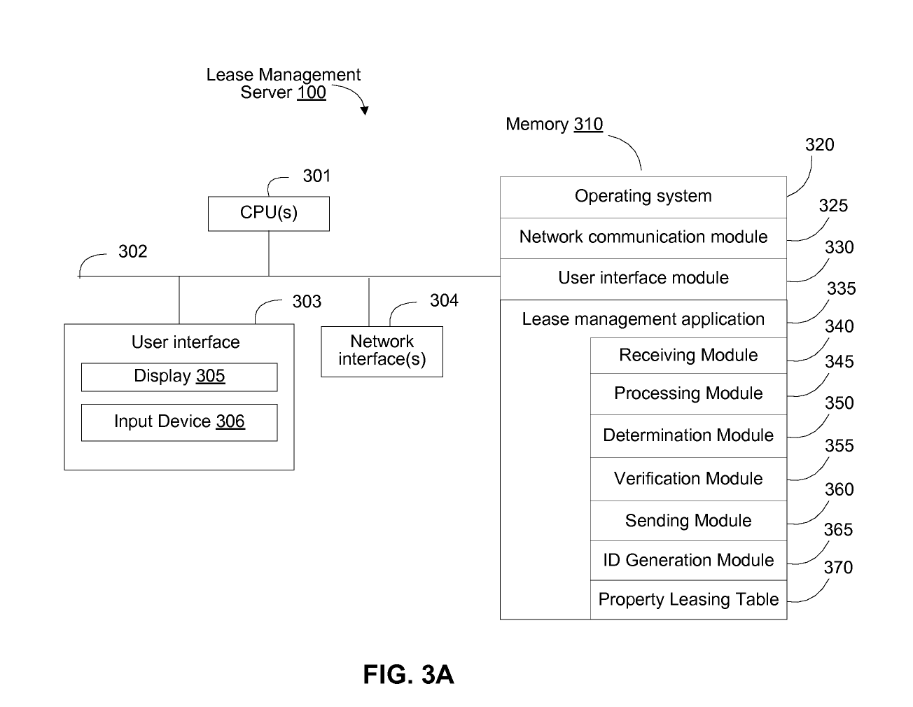

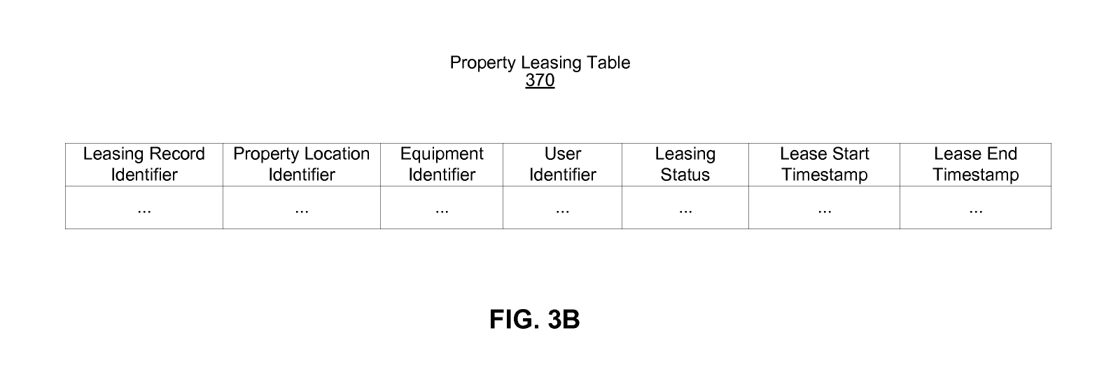

At S14, upon receipt of the lease initiation request, the lease management server 100 extracts the property location identifier from the request and identifies the property (e.g., the parking spot) associated with the property location identifier. In some embodiments, the lease management server 100 maintains a data structure (e.g., a property leasing table 370 as described in connection with FIG. 3B) to keep track of the status of each property under its management. A real property for lease (e.g., a parking spot or a locker) can be uniquely identified by its property location identifier and a personal property (e.g., a bicycle) may be uniquely identified by an equipment identifier because the personal property may be put at different locations at the same or different rental sites. The leasing status of a property may be either “available for lease” or “unavailable for lease.” After identifying the property location identifier and/or the equipment identifier, the lease management server 100 queries the property leasing table to determine whether the property is available for lease or not at S14A. If the query result indicates that the property is available for lease, the lease management server 100 updates the status of the property in the table to reflect that the property is no longer available for another user until the current user surrenders the property. If the query result indicates that the property is not available for least, the lease management server 100 sends a message to the client device 500, the message indicating that the property is currently not available for lease. In some embodiments, the lease initiation request also includes a user identifier associated with the client device 500. This user identifier is also included in the table to indicate which user is currently leasing a particular property. If the property's lease is not for free, the lease management server 100 will send a query including information of a bank account associated with the user identifier to the bank server 200 and check whether the bank account has at least a predefined amount of credit (e.g., $250) before sending the instruction to release the property. After determining that the bank account has sufficient credit, the lease management server 100 then instructs the bank server to place the predefined amount of credit on hold for covering the leasing cost. Finally, the lease management server 100 updates an entry or record in the table corresponding to the property to be released and then sends an instruction to the property control device 400 to release the property at S15. The instruction may include the property location identifier and the equipment identifier (if the property for rental is a personal property). As shown in FIG. 3B, a lease record in the property leasing table 370 may include a lease record identifier that uniquely identifies the record in the table, a property location identifier corresponding to a location of the property at the rental site, an equipment identifier (if the property for lease is a personal property), a user identifier that identifies the user who has leased the property, a leasing status, and two timestamps indicating when the lease starts and ends, respectively. Note that the lease end timestamp may be empty until when the user returns the property to a rental site.

At S17, in response to the instruction, the property control device 400 releases the property. Note that the release of a property may or may not involve an active operation taken by the property control device 400. For example, if the parking spot has a lock, the property control device 400 then unlocks the lock by sending a unlock signal to the electronic device at the parking spot. If the parking spot does not have a lock, the property control device 400 does not need to take any further action to release the parking spot. Actually, the user may already park the car at the parking spot. In some embodiments, the property control device 400 returns an acknowledgement to the lease management server 100 after releasing the property to the user. In some other embodiments, the property control device 400 does not return an acknowledgement to the lease management server 100 after releasing the property to the user. In either case, the lease management server 100 sends a lease initiation message to the client device 500 at S16 after sending the instruction to release the property. In some embodiments, the lease initiation message includes an identifier of a record corresponding to the property in the table managed by the lease management server 100. At S16A, the client device 500 displays the message to the user. FIG. 5D depicts a message indicating that the parking spot no. 122 has been rented by the user. Since the message is saved in the client device 500, the user can easily bring it back on the display of the client device 500 and find out where the car is parked.

At S18, when the user comes back to pick up the car, he or she sends a lease termination request to the lease management server 100 from the client device 500. In some embodiments, the lease termination request includes the identifier of the lease record in the table managed by the lease management server 100 and a timestamp indicating when the lease ends. In some embodiments, the lease management server 100 periodically updates the property location identifier of a property. FIG. 5E depicts a new property location identifier 211 (i.e., a different 2D barcode) that is different from the property location identifier 201 the user used to generate the lease initiation request. Similarly, the user can scan the new 2D barcode as shown in FIG. 5F and generate the lease termination request by pressing the “return” button shown in FIG. 5G. In this case, the lease termination request does not need to include an actual timestamp. The new 2D barcode is included in the lease termination request so that the lease management server 100 can convert it into a timestamp later on.

Upon receipt of the lease termination request, the lease management server 100 determines the current status of the property at S19. If the current status is “not available for lease,” the lease management server 100 changes the status to “available for lease.” If the lease is not for free, the lease management server 100 then verifies the usage information at S20. For example, the lease management server 100 compares the two timestamps in the lease initiation request and the lease termination request to determine the length of the lease and then determines the total charge for this lease. In addition, the lease management server 100 may check whether the user identifier in the lease initiation request is the same as the user identifier in the lease termination request. If not, the lease management server 100 may contact the user identifier in the lease initiation request to confirm that the user identifier in the lease termination request is authorized to terminate the lease. At S21, the lease management server 100 sends an instruction to the property control device 400 to repossess the property.

At S22, the property control device 400 repossesses the property. If the property is a locker, the property control device 400 first unlocks the locker and waits for a predefined period of time (e.g., 3 minutes) for the user to take out his or her personal properties stored in the locker and then locks it again after the predefined period of time. If the property is a park spot not within a parking garage but a curb-side parking spot, the property control device 400 may cause the electronic device near the parking spot to take a picture of the parking spot and compare the picture with a predefined image (e.g., another picture taken when the parking spot is empty). If the difference between the two images is less than a predefined threshold, the property control device 400 determines that the user indeed has surrendered the parking spot and then sends a response to the lease management server 100 indicating so. Upon receipt of the response, the lease management server 100 sends a lease termination message to the client device 500 at S23. At S23A, the client device 500 displays a message indicating that the parking spot has been successfully surrendered as shown in FIG. 5H. If the property control device 400 determines that the user has not yet surrendered the parking spot, it will not send a response to the lease management server 100. For example, if the user does not move his or her car away from the parking spot, the image comparison described above can tell that the user has not surrendered the parking spot yet. In this case, the property control device 400 may cause the electronic device near the parking spot to generate visual or audio cues indicating that the user has been trying to cheat on the system. In some embodiments, the property control device 400 may submit a report to the lease management server 100. Upon receipt of such report, the lease management server 100 may either send a warning message to the client device 500 or impose a fine upon the user's bank account. After the confirming that the property has been surrendered, the lease management server 100 may determine a rental fee based on the two timestamps and sends instructions to the bank server 200 to transfer the rental fee from the user's bank account to another bank account associated with the property location identifier (e.g., the bank account of a government agency or a private entity that is responsible for managing the parking spot).

FIG. 3A is a block diagram of a lease management server 100 according to some embodiments of the present application. The lease management server 100 typically includes one or more processing units (CPU's) 301, one or more network or other communications interfaces 304, memory 310, and one or more communication buses 302 for interconnecting these components. The communication buses 302 may include circuitry (sometimes called a chipset) that interconnects and controls communications between these components. The lease management server 100 may include a user interface 303, which may further include a display 305 and an input device 306 (e.g., keyboard). Memory 310 may include high speed random access memory and may also include non-volatile memory, such as one or more magnetic disk storage devices. Memory 310 may include mass storage that is remotely located from the CPU's 301. In some embodiments, memory 310, or alternately the non-volatile memory device(s) within memory 310, comprises a non-transitory computer readable storage medium. Memory 310 or the computer readable storage medium of memory 310 stores the following elements, or a subset of these elements, and may also include additional elements:
an operating system 320 that includes procedures for handling various basic system services and for performing hardware dependent tasks;
a network communication module 325 that is used for connecting the lease management server 100 to a remote server (e.g., the bank server 200 in FIG. 1) or other computing devices (e.g., the property control device 400 or the client device 500) via one or more communication networks (wired or wireless), such as the Internet, other wide area networks, local area networks, metropolitan area networks, and so on;
a user interface module 330 configured to receive user inputs through the user interface 303 for controlling the operations of the lease management server 100; and
a lease management application 335 for managing various aspects relating to the leases of properties to different users; in some embodiments, the lease management application 335 further including:
   a receiving module 340 for receiving messages from the property control device 400 or the client device 500 in connection with completing a transaction of leasing a property to a user as described above in connection with FIG. 2;
   a processing module 345 for processing the messages from the property control device 400 or the client device 500, e.g., extracting a property location identifier and a user identifier from a lease initiation request, and identifying a lease record in the property leasing table 370 as described above in connection with FIG. 2;
   a determination module 350 for determining whether the property associated with the property location identifier is available for lease or not and whether the user identifier has a bank account of sufficient credit for leasing the property as described above in connection with FIG. 2;
   a verification module 355 for verifying the lease usage information, e.g., comparing two timestamps to determine the length of the lease and optionally the cost of the lease and comparing two user identifiers in the two requests as described above in connection with FIG. 2;
   a sending module 360 for sending messages to the property control device 400, the client device 500, or the bank server 200 in connection with completing a transaction of leasing a property to a user as described above in connection with FIG. 2;
   a property location identifier generation module 365 for generating new property location identifiers for a property managed by the lease management server 100, which can be used for uniquely identifying a lease transaction for a particular property and keeping track of the length of a property lease, etc.; and
   a property leasing table 370 for maintaining the lease records for different properties, e.g., updating a lease record for a particular property at the beginning or end of the lease as described above in connection with FIG. 2.

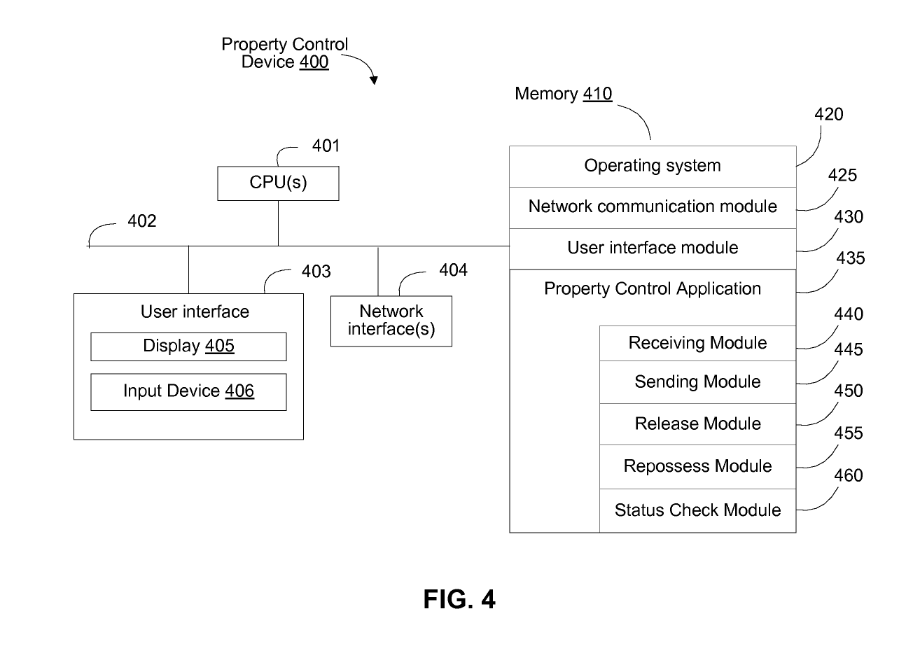

FIG. 4 is a block diagram of a property control device 400 according to some embodiments of the present application. The property control device 400 typically includes one or more processing units (CPU's) 401, one or more network or other communications interfaces 404, memory 410, and one or more communication buses 402 for interconnecting these components. The communication buses 402 may include circuitry (sometimes called a chipset) that interconnects and controls communications between these components. The property control device 400 may include a user interface 403, which may further include a display 405 and an input device 406 (e.g., keyboard). Memory 410 may include high speed random access memory and may also include non-volatile memory, such as one or more magnetic disk storage devices. Memory 410 may include mass storage that is remotely located from the CPU's 401. In some embodiments, memory 410, or alternately the non-volatile memory device(s) within memory 410, comprises a non-transitory computer readable storage medium. Memory 410 or the computer readable storage medium of memory 410 stores the following elements, or a subset of these elements, and may also include additional elements:
an operating system 420 that includes procedures for handling various basic system services and for performing hardware dependent tasks;
a network communication module 425 that is used for connecting the property control device 400 to a remote server (e.g., the lease management server 100 in FIG. 1) via one or more communication networks (wired or wireless), such as the Internet, other wide area networks, local area networks, metropolitan area networks, and so on;
a user interface module 430 configured to receive user inputs through the user interface 403 for controlling the operations of the property control device 400; and
a property control application 435 for releasing or repossessing a property in accordance with instructions from the lease management server 100; in some embodiments, the property control application 435 further including:
   a receiving module 440 for receiving messages from the lease management server 100 in connection with completing a transaction of leasing a property to a user as described above in connection with FIG. 2;
   a sending module 445 for sending messages to the lease management server 100 in connection with completing a transaction of leasing a property to a user as described above in connection with FIG. 2;
   a release module 450 for releasing a property to a user in accordance with an instruction from the lease management server 100, e.g., unlocking a locker or updating a property location identifier displayed near the property after the release of the property as described above in connection with FIG. 2;
   a repossess module 455 for repossessing a property from a user in accordance with an instruction from the lease management server 100, e.g., locking a locker or updating a property location identifier displayed near the property after the repossession of the property as described above in connection with FIG. 2; and
   a status check module 460 for checking whether the property has been released or repossessed, e.g., taking pictures of a parking spot and comparing the pictures with predefined images to determine whether the parking spot is occupied or empty as described above in connection with FIG. 2.

Note that the method of property lease management disclosed in the present application may be used for other types of public property usage. For example, this method may be used for collecting toll fee of using highway or crossing a bridge. In this case, a driver scans a first unique identifier displayed by a toll collection system at the entrance of the highway using his or her mobile device and submits a first request (like the lease initiation request) to the lease management server 100. The first request includes the first unique identifier, which identifies the location and time of the driver entering the highway. The gate to the highway is not open until after the user is authorized to use the highway, which may involve the lease management server 100 putting a hold of a certain amount of money from the driver's bank account and sending an instruction to the toll collection system to open the entrance to the highway. Compared with the parking spot example described above, the highway can be shared by multiple users. Therefore, the leasing status of the highway is different from that of the parking spot, which is exclusively occupied by one user at a time. Note that the lease management server 100 may or may not send a message like the lease initiation message to the client device in this case because the driver does not need this message to terminate the usage of the highway. In other words, the steps S16 and S16A may be optional in this example.

When the driver exits the highway, the driver may scan a second unique identifier displayed by the toll collection system at the exit of the highway and send a second request (like the lease termination request) to the lease management server 100. This second unique identifier identifies the location and time of the driver leaving the highway. In response to the second request, the lease management server 100 may deduct a corresponding amount of toll fee from the driver's bank account. In some embodiments, the driver may provide his or her unique user identifier to the toll collection system at the entrance and exit of the highway by, e.g., displaying a 2D barcode or broadcasting an audio fingerprint including the driver's user identifier. After completing the toll fee deduction, the lease management server 100 may send a confirmation message to an account associated with the driver, indicating the usage details by the driver. Compared with today's electronic tolling system, this approach does not require that the driver install any special equipment or even some special software application on his or her mobile device. This process can potentially reduce the traffic jam at the entrance and exit of a highway or bridge that requires toll fee.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present application. First ranking criteria and second ranking criteria are both ranking criteria, but they are not the same ranking criteria.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the present application to the precise forms disclosed. Many modifications and variations are possible in view of the above teachings. The implementations were chosen and described in order to best explain principles of the present application and its practical applications, to thereby enable others skilled in the art to best utilize the present application and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method for managing leases of properties to different users, comprising:
at a computer server having one or more processors and memory storing program modules to be executed by the one or more processors:
receiving a lease initiation request from a client device, the lease initiation request including a property location identifier and a user identifier;
identifying a property associated with the property location identifier and determining whether the property is available for lease;
in accordance with a determination that the property is available for lease:
causing a property control device to release the property;
updating a lease record for the property, the lease record including the property location identifier, the user identifier, and a first timestamp corresponding to an initiation of the lease of the property; and
sending a lease initiation message to the client device, the lease initiation message including an identifier of the lease record;
receiving a lease termination request from the client device, the lease termination request including the identifier of the lease record;
in response to the lease termination request, causing the property control device to repossess the property;
after confirmation by the property control device of repossessing the property:
updating the lease record for the property, the lease record including a second timestamp corresponding to a termination of the lease of the property; and
sending a lease termination message to the client device.

2. The method of claim 1, further comprising:
in accordance with a determination that the property is not available for lease:
sending a message to the client device, the message indicating that the property is currently not available for lease.

3. The method of claim 1, further comprising:
after receiving the lease initiation request from the client device:
determining whether the property's lease is for free or not; and
if the property's lease is not for free, causing the property control device to release the property after determining that there is at least a predefined amount of credit at a bank account associated with the user identifier.

4. The method of claim 3, wherein updating the lease record for the property further includes placing the predefined amount of credit at the bank account associated with the user identifier on hold.

5. The method of claim 3, further comprising:
after confirmation by the property control device of repossessing the property:
determining a rental fee for the property based, at least in part, on the first timestamp and the second timestamp; and
causing a transfer of the rental fee from the bank account associated with the user identifier to a bank account associated with the property location identifier.

6. The method of claim 1, wherein the lease initiation message includes location information of the property.

7. The method of claim 1, wherein the property for lease is one selected from the group consisting of a parking spot, a locker, and a personal property for rental.

8. A method for managing leases of properties to different users, comprising:
at a property control device having one or more processors and memory storing program modules to be executed by the one or more processors:
presenting a unique property location identifier for each of a plurality of properties for lease;
receiving a property release message from a remote server, the property release message including a property location identifier;
in response to the property release message, releasing a property associated with the property location identifier in the property release message to a user;
receiving a property repossession message from the remote server, the property repossession message including the property location identifier;
in response to the property repossession message, determining whether the user has surrendered the property associated with the property location identifier;
after determining that the property has been surrendered:
repossessing the property surrendered by the user; and
sending a property repossession confirmation message to the remote server.

9. The method of claim 8, wherein presenting the unique property location identifier for each of a plurality of properties for lease further includes broadcasting an audio fingerprint including the unique property location identifier and the audio fingerprint is detectable by a mobile phone but is not audible by human beings.

10. The method of claim 8, wherein presenting the unique property location identifier for each of a plurality of properties for lease further includes displaying one selected from the group consisting of a 1-D barcode, a 2-D barcode, and a 3-D barcode at a location near the property for lease.

11. The method of claim 8, wherein the unique property location identifier of a property for lease is periodically updated by the remote server.

12. The method of claim 8, wherein the property for lease is a parking spot and determining whether the user has surrendered the property associated with the property location identifier further includes:
taking a picture of the parking spot and comparing the picture with a predefined image, wherein the predefined image indicates that the parking spot is empty; and
determining that the parking spot is empty if a difference between the picture and the predefined image is less than a predefined threshold.

13. The method of claim 8, further comprising:
after repossessing the property surrendered by the user:
generating a visual signal near the property, the visual signal indicating that the property is available for lease to next user.

14. A computer system, comprising:
one or more processors;
memory; and
one or more program modules to be executed by the one or more processors, the program modules including instructions for:
receiving a lease initiation request from a client device, the lease initiation request including a property location identifier and a user identifier;
identifying a property associated with the property location identifier and determining whether the property is available for lease;
in accordance with a determination that the property is available for lease:
causing a property control device to release the property;
updating a lease record for the property, the lease record including the property location identifier, the user identifier, and a first timestamp corresponding to an initiation of the lease of the property; and
sending a lease initiation message to the client device, the lease initiation message including an identifier of the lease record;
receiving a lease termination request from the client device, the lease termination request including the identifier of the lease record;
in response to the lease termination request, causing the property control device to repossess the property;
after confirmation by the property control device of repossessing the property:
updating the lease record for the property, the lease record including a second timestamp corresponding to a termination of the lease of the property; and
sending a lease termination message to the client device.

15. The computer system of claim 14, wherein the program modules further include instructions for:
in accordance with a determination that the property is not available for lease:
sending a message to the client device, the message indicating that the property is currently not available for lease.

16. The computer system of claim 14, wherein the program modules further include instructions for:
after receiving the lease initiation request from the client device:
determining whether the property's lease is for free or not; and
if the property's lease is not for free, causing the property control device to release the property after determining that there is at least a predefined amount of credit at a bank account associated with the user identifier.

17. The computer system of claim 16, wherein the instruction for updating the lease record for the property further includes instructions for placing the predefined amount of credit at the bank account associated with the user identifier on hold.

18. The computer system of claim 16, wherein the program modules further include instructions for:
after confirmation by the property control device of repossessing the property:
determining a rental fee for the property based, at least in part, on the first timestamp and the second timestamp; and
causing a transfer of the rental fee from the bank account associated with the user identifier to a bank account associated with the property location identifier.

19. A non-transitory computer-readable storage medium storing one or more program modules to be executed by a computer system having one or more processors, the program modules including instructions for:
receiving a lease initiation request from a client device, the lease initiation request including a property location identifier and a user identifier;
identifying a property associated with the property location identifier and determining whether the property is available for lease;
in accordance with a determination that the property is available for lease:
causing a property control device to release the property;
updating a lease record for the property, the lease record including the property location identifier, the user identifier, and a first timestamp corresponding to an initiation of the lease of the property; and
sending a lease initiation message to the client device, the lease initiation message including an identifier of the lease record;
receiving a lease termination request from the client device, the lease termination request including the identifier of the lease record;
in response to the lease termination request, causing the property control device to repossess the property;
after confirmation by the property control device of repossessing the property:
updating the lease record for the property, the lease record including a second timestamp corresponding to a termination of the lease of the property; and
sending a lease termination message to the client device.

20. The non-transitory computer-readable storage medium of claim 19, wherein the program modules further include instructions for:
in accordance with a determination that the property is not available for lease:
sending a message to the client device, the message indicating that the property is currently not available for lease.
